(19) United States
(12) Patent Application Publication
(10) Pub. No.: US 2006/0133204 A1
(43) Pub. Date: Jun. 22, 2006

(54) Method to measure and locate a fluid communication pathway in a material behind a casing

(76) Inventor: Benoit Froelich, Marly le Roi (FR)

Correspondence Address: Office of Patent Counsel;Schlumberger Oilfield Services, 200 Gillingham Lane, MD200-9, Sugar Land, TX, 77478, US

(21) Appl. No.: 11/298,357

(22) Filed: Dec. 9, 2005

(30) Foreign Application Priority Data
Dec. 20, 2004 (EP) 04293063.6

(51) Int. Cl. G01V 1/00

(52) U.S. Cl. 367/35

(57) ABSTRACT

The invention provides a method for measuring and locating a fluid communication pathway in a material behind a casing wall, wherein said material is disposed in an annulus between said casing and a geological formation, and said method comprising: measuring a set of parameters of the material behind the casing within a range of radius, depths and azimuthal angles; defining sections comprising a sub-set of parameters wherein said sub-set of parameters is taken in said set of parameter for a given range of radius, depths and azimuthal angles included in said range of radius, depths and azimuthal angles; defining for each section a first limit zone and a second limit zone in frontier of said given range; determining among said sections the ones that comprise a continuous fluid communication pathway from said first limit zone to said second limit zone, said sections being renamed in retained sections; determining from said continuous fluid communication pathway an area or a width of pathway versus depth for each of said retained sections; extracting a fluid communication index versus depth for the material behind the casing, wherein said fluid communication index versus depth: depends of said area or width for retained sections and, is equal to zero for non retained sections; deducing from said fluid communication index the existence and location of fluid communication pathway in said material behind said casing wall.

### FIELD OF THE INVENTION

This present invention relates generally to acoustical investigation of a borehole and to the detection of leak and fluid communication pathway in a material behind a casing.

### DESCRIPTION OF THE PRIOR ART

In a well completion, a string of casing or pipe is set in a wellbore and a fill material referred to as cement is forced into the annulus between the casing and the earth formation. After the cement has set in the annulus, it is common practice to use acoustic non-destructive testing methods to evaluate its integrity. This evaluation is of prime importance since the cement must guarantee zonal isolation between different formations in order to avoid flow of fluids from the formations (water, gas, oil) through the annulus.

FIG. 1 shows a schematic diagram of a cased well. The cased well generally includes a number of interfaces 12₁, 12₂, 12₃ at junctures of differing materials within a wellbore 11. A “first interface” 12₁ exists at the juncture of a borehole fluid 13 in a casing 14 and the casing 14. The casing 14 is typically made of steel. A “second interface” 12₂ is formed between the casing 14 and an annulus 15 behind the casing 14. If cement 112 is properly placed in the annulus 15, the “second interface” 12₂ exists between the casing 14 and the cement 112. A “third interface” 12₃ exists between the annulus 15 and a formation 16. The formation 16 may comprise a plurality of layers, e.g., an oil-producing layer 17, a gas-producing layer 18 and a water-bearing layer 19.

A micro-annulus 111 may appear at the second interface 122, between the casing 14 and the cement 112. A forming of the micro-annulus 111 is due to a variation of pressure inside the casing 14. Even if the micro-annulus 111 is present, the layers 17, 18, 19 may be properly sealed off by the cement 112.

However, if a void 113 appears between the casing and the formation, the cement may fail to provide isolation of one layer 17, 18, 19 from another. Fluids, e.g., oil, gas or water, under pressure may migrate from one layer 17, 18, 19 to another through the void 113, and create a hazardous condition or reduce production efficiency. In particular, migration of water into the oil-producing layer 17 may, in some circumstances, render a well non-exploitable. Also, migration of oil into the water-bearing layer 19 is environmentally and economically undesirable. Thus, imaging the annulus content may be important for reliable determination of the hydraulic isolation of the different layers of a formation.

Another need for through-the-casing imaging exists in the process of hydraulic fracturing, which typically takes place after a well has been cased, and is used to stimulate the well for production. Often, the fracturing process is accompanied by sanding, whereby certain strata of the formation release fine sand that flows through casing perforations into the well, and then up to the surface, where it can damage production equipment. This problem can be remedied if the sand-producing zones are detected as could be done, for example, with an imaging technology capable of operating through the casing.

Various cement evaluating techniques using acoustic energy have been used in prior art to investigate a description of a zone behind a thick casing wall with a tool located inside the casing 14, for example U.S. Pat. No. 2,538,114 to Mason; U.S. Pat. No. 4,255,798 to Havira; U.S. Pat. No. 6,483,777 to Zeroug and U.S. Pat. No. 3,401,773, to Synott, et al. Those techniques consist in measuring the acoustic impedance of the matter behind the casing 14. Effectively the value of the impedance of water is near 1.5 MRayl, whereas the value of impedance of cement is typically higher (for example this impedance is near 8 MRayl for a class G cement). If the measured impedance is below a predefined threshold, it is considered that the matter is water or mud. And if the measured impedance is above the predefined threshold, it is considered that the matter is cement, and that the quality of the bond between cement and casing is satisfactory.

Generally, the output map of the impedance of the matter within the annulus is plotted as a function of the depth z and the azimuthal angle θ. To commonly read the map on a paper, the cylindrical map is projected on a plane map with on X-axis the angle θ from 0° to 360° and on Y-axis the depth in meter. Because, the impedance of the matter within the annulus informs on the state of the material behind the casing (solid, liquid or gas), the value of the impedance of the matter within the annulus is translated in colors where intensity of the color informs on the probability of the material state: yellow for solid, blue for liquid and red for gas. The plotted map has the advantage to be easily readable, nevertheless the colors informing on the state of the matter do not inform on defects in the matter within the annulus which would lead for example to hydraulic communication between two depth intervals and also do not inform when a leak is present on the intensity of the hydraulic communication pathway. It is an object of the invention to develop a method for measuring and locating a fluid communication pathway in a material behind a casing wall.

### SUMMARY OF THE INVENTION

The invention provides a method for locating and measuring a fluid communication pathway in a material behind a casing wall, wherein said material is disposed in an annulus between said casing and a geological formation, said method using a logging tool positionable inside the casing and said method comprising: detecting a set of parameters of the material behind the casing at different positions with said logging tool, evaluating location of fluid communication pathway from said set of parameters and said positions, and measuring size of said fluid communication pathway from said set of parameters.

Preferably, the method further comprises guiding and rotating the logging tool inside the casing in order to evaluate the description of the material behind the casing within a range of radius, depths and azimuthal angles. In this way, the logging tool ensures a cylindrical map of the annulus.

Preferably, the method for measuring and locating a fluid communication pathway in a material behind a casing wall, wherein said material is disposed in an annulus between said casing and a geological formation, comprises the steps of:
measuring a set of parameters M of the material behind the casing within a range E of radius, depths and azimuthal angles;
defining sections Sᵢ comprising a sub-set of parameters Mᵢ wherein said sub-set of parameters Mᵢ is taken in said set of parameter M for a given range Eᵢ of radius, depths and azimuthal angles included in said range E of radius, depths and azimuthal angles;
defining for each section Sᵢ a first limit zone L₁ᵢ and a second limit zone L₂ᵢ in frontier of the range Eᵢ;
determining among said sections Sᵢ the ones that comprise a continuous fluid communication pathway from said first limit zone L₁ᵢ to said second limit zone L₂ᵢ, said sections Sᵢ being renamed in retained sections Rᵢ;
determining from said continuous fluid communication pathway an area sᵢ of pathway versus depth for each of said retained sections Rᵢ;
extracting a fluid communication index versus depth for the material behind the casing, wherein said fluid communication index versus depth: depends of sᵢ for retained sections Rᵢ and is equal to zero for non retained sections Sᵢ;
deducing from said fluid communication index the existence and location of fluid communication pathway in said material behind said casing wall.

In another embodiment, when the sections Sᵢ are surfaces, the fifth step is replaced by determining from said continuous fluid communication pathway a width sᵢ of pathway versus depth for each of said retained sections Rᵢ. Effectively the plotted map may be a 2D or a 3D representation of the characteristic of the matter within the annulus and the fluid communication pathway may be shown as a 2D channel with a width or a 3D channel with an area.

In a preferred embodiment, the set of parameters of the material behind the casing is any taken in the list of: density of the material, acoustic impedance of the material, state of the material, shear wave velocity or compressional wave velocity of the material. All those parameters inform on the quality of the material within the annulus.

In a first embodiment, the range E is defined by a minimum radius and a maximum radius; a minimum depth and a maximum depth; and an angle varying between zero and three hundred sixty degrees. Preferably, the sections Sᵢ are cylindrical sections with a range Eᵢ defined by a minimum radius and a maximum radius; a minimum depth and a maximum depth; and an angle varying between zero and three hundred sixty degrees. Preferably also, for each section Sᵢ, the first limit zone L₁ᵢ is the frontier defined at lower depth of said section Sᵢ and the second limit zone L₂ᵢ is the frontier defined at upper depth of said section Sᵢ. The plotted map is a 3D representation and the subdivision corresponds to volumes of cylindrical sections. This simplification reduces the complexity and the time of processing of the additional steps. In this way, for cylindrical sections the continuous fluid communication pathway is determined from lower depth to upper depth of range Eᵢ.

In a second embodiment, the range E is defined by a minimum depth and a maximum depth; and an angle varying between zero and three hundred sixty degrees. Preferably, the sections Sᵢ are cylindrical sections with a range Eᵢ defined by a minimum depth and a maximum depth; and an angle varying between zero and three hundred sixty degrees. Preferably also, for each section Sᵢ, the first limit zone L₁ᵢ is the frontier defined at lower depth of said section Sᵢ and the second limit zone L₂ᵢ is the frontier defined at upper depth of said section Sᵢ. The plotted map is a 2D representation and the subdivision corresponds to surfaces of cylindrical sections. This simplification reduces the complexity and the time of processing of the additional steps. In this way, for cylindrical sections the continuous fluid communication pathway is determined from lower depth to upper depth of range Eᵢ.

In a preferred embodiment the continuous fluid communication pathway is determined by the step of: defining from the sub-set of parameters Mᵢ, zones where a fluid can exist and determining if a continuous pathway is possible through said zones. Preferably, a filter may be applied to said zones where a fluid can exist to retain only preferential zones above a predefined threshold value of surface or volume. The determination of the zones where a fluid can occur and/or exist is done through the interpretation of the measured parameters Mᵢ, nevertheless noise or error may be present in the measured data and a preliminary post processing of the data is useful.

### BRIEF DESCRIPTION OF THE DRAWINGS

Further embodiments of the present invention can be understood with the appended drawings:

FIG. 1 contains a schematic diagram of a cased well.

FIG. 2 shows a schematic diagram of a logging tool used in a casing to perform measurements of a set of parameters to evaluate the integrity of the material behind the casing.

FIG. 3A shows a 2D representation in cylindrical co-ordinates.

FIG. 3B shows a 3D representation in cylindrical co-ordinates.

FIG. 3C illustrates a surface section of the matter within the annulus.

FIG. 3D illustrates a volume section of the matter within the annulus.

FIG. 4 shows a block diagram of the method to measure and locate a fluid communication pathway in a material behind a casing wall according to the invention.

FIG. 5A shows an example of determination of fluid communication pathway.

FIG. 5B shows an example of determination of width of the fluid communication pathway.

FIG. 6 shows an example of application of the method according to the invention.

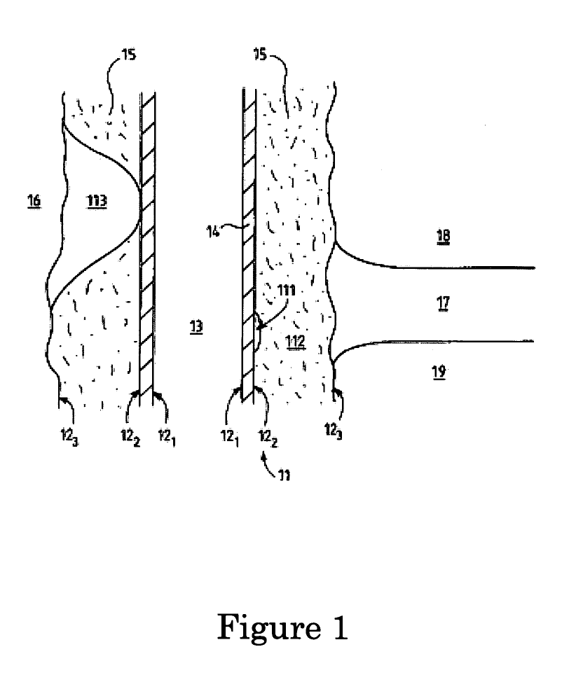

### DETAILED DESCRIPTION

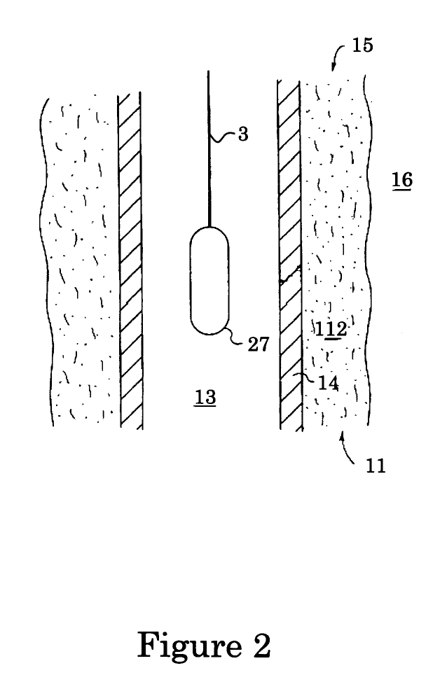

FIG. 2 is an illustration of a logging tool 27. A description of a zone behind a casing 14 is evaluated by estimating a quality of a fill-material within an annulus 15 between the casing 14 and a geological formation 16. A logging tool 27 is lowered by armored multi-conductor cable 3 inside the casing 14 of a wellbore 11. The matter within the annulus 15 may be any type of fill-material that ensures isolation between the casing 14 and the geological formation 16 and between the different types of layers of the geological formation. In the embodiment here described, the fill-material is cement 112, nevertheless other fill-material may be used and method according to the invention may still be applied. For examples the fill material may be a granular or composite solid material activated chemically by encapsulated activators present in material or physically by additional logging tool present in the casing. In a further embodiment, the fill material may be a permeable material, the isolation between the different types of layers of the geological formation is no more ensured, but its integrity can still be evaluated.

The logging tool is raised by surface equipment not shown and the depth of the tool is measured by a depth gauge not shown, which measures cable displacement. In this way, the logging tool may be moved along a vertical axis inside the casing, and may be rotated around the vertical axis, thus providing an evaluation of the description of the zone behind the casing within a range of depths and azimuthal angle. A set of parameters informing on the characteristic of the matter behind the casing is measured by the logging tool 27. Furthermore, the measurement may be performed for a given depth and a given azimuthal angle, within a range of radius, providing thus an evaluation in volume of the description of the zone behind the casing. Those measurements can be any taken in the list of: acoustic impedance, density, shear wave velocity, or compressional wave velocity. In the embodiment here described, the set of parameters is the acoustic impedance measurement.

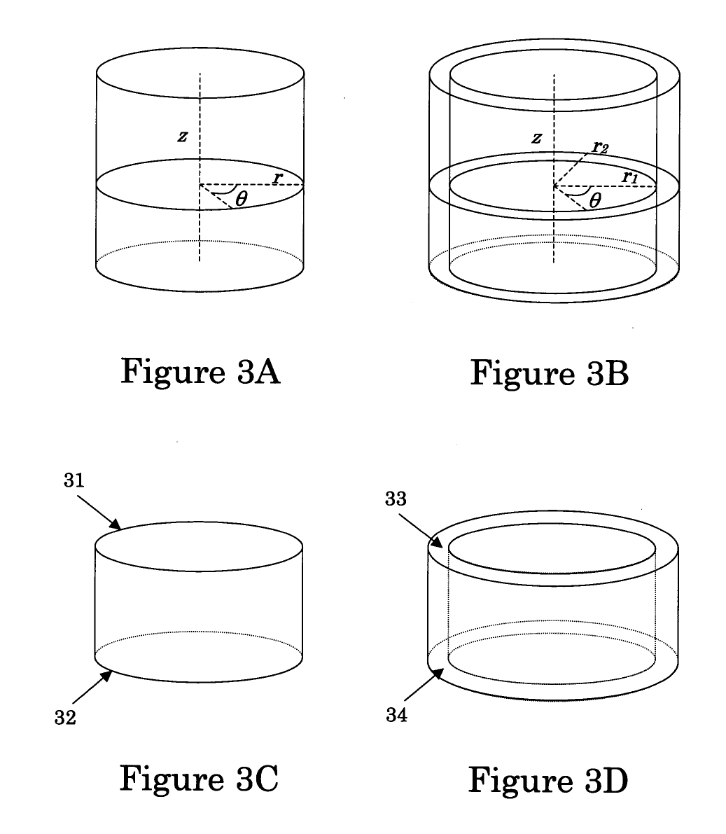

Typically, the quality of the fill-material depends on the state of the matter within the annulus. To evaluate the quality of cement and its integrity, the acoustic impedance of the matter within the annulus, which informs on the state of the matter (solid, liquid or gas), is measured. If the measured impedance is below 0.2 MRayls, the state is gas: it is considered that the fill-material behind the casing has voids, no cement is present. If the measured impedance is between 0.2 MRayls and 2 MRayls, the state is liquid: the matter is considered to be water or mud. And if the measured impedance is above 2 MRayls, the state is solid: the matter is considered to be cement, and the quality of the bond between cement and casing is satisfactory. Finally, the values of the impedance of the matter within the annulus are plotted as a 2D representation in cylindrical co-ordinates as a function of the depth z and the azimuthal angle θ for a range E of depths and azimuthal angles (FIG. 3A). The result is the impedance of a surface section of the matter within the annulus (FIG. 3C). In other embodiment, the values of the impedance of the matter within the annulus are plotted as a 3D representation in cylindrical co-ordinates as a function of the radius r, the depth z and the azimuthal angle θ for a range E of radius, depths and azimuthal angles (FIG. 3B). The result is the impedance of a volume section of the matter within the annulus (FIG. 3D). And the value of the impedance of the matter within the annulus is translated in colors where intensity of the color is depended of the impedance and therefore informs on the probability of the material state: yellow for solid, blue for liquid and red for gas.

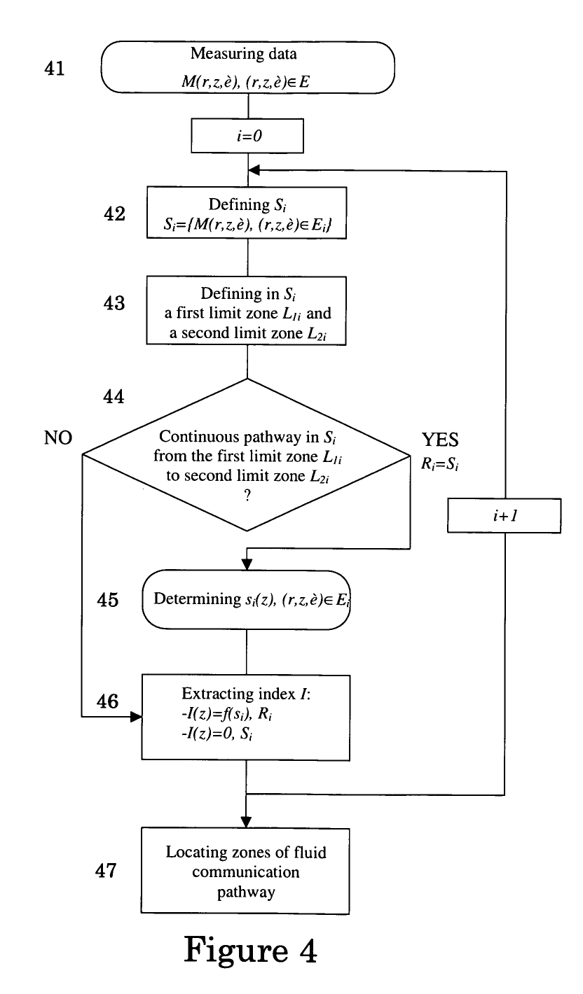

FIG. 4 is a block diagram of the method of detection of leak and fluid communication pathway according to the present invention. The measurement process and data extracting process has been done by the logging tool 27 and by the processing means not shown. Therefore a set of parameters, informing on the characteristic of the matter behind the casing, is given. The set of parameters comprises data, noted M(r, z, θ), where r is the radius, z is the depth and θ the azimuthal angle. The radius, the depth and the azimuthal angle can vary in a range E. Generally E comprises, radius from r₀ to rₙ, depths from z₀ to zₙ and azimuthal angles from θ₀ to θₙ. Preferably, r₀ is the external radius of the casing and rₙ, is the external radius of the annulus; z₀ is the altitude zero and zₙ represents the depth; and azimuthal angles vary between 0 and 360 degrees.

The first step 41 of the method according to the invention defines the set of parameters comprising the measured data M(r, z, θ), (r, z, θ)εE. In a second step 42, the set of parameters of the measured data M(r, z, θ), (r, z, θ)εE is split in a number N of sub-sets of parameters Mᵢ(r, z, θ), iε[1, N] These sub-sets of parameters are called sections Sᵢ, iε[1, N] and comprise measured data when the radius, the depth and the azimuthal angle vary in a range Eᵢ. The ranges Eᵢ, iε[1, N] are included in the range E. Generally Eᵢ comprises radius from rᵢ₀ to rᵢₙ, depths from zᵢ₀ to zᵢₙ, and azimuthal angles from θᵢ₀ to θᵢₙ. The ranges Eᵢ, iε[1, N] may be superposed or not. These sub-sets of parameters are called sections, because they correspond effectively to sections in the matter behind the casing: the sub-sets of parameters Mᵢ(r, z, θ), iε[1, N] characterized the matter behind the casing for the sections Sᵢ, iε[1, N]. These sections Sᵢ, iε[1, N] are therefore defined as Sᵢ={M (r, z, θ), (r, z, θ)εEᵢ}, iε[1, N].

In a third step 43, for each section Sᵢ a first limit zone L₁ᵢ and a second limit zone L₂ᵢ are defined in frontier of the range Eᵢ. The frontier of the range Eᵢ is defined as in mathematics the boundary of the set of values Eᵢ. The limit zones are taken in this boundary of the set of values Eᵢ. When the section Sᵢ is a cylindrical surface as in FIG. 3C, the first limit zone may be the up circle limit 31 and the second limit zone may be the down circle limit 32. When the section Sᵢ is a cylindrical volume as in FIG. 3D, the first limit zone may be the up crown limit 33 and the second limit zone may be the down crown limit 34.

In a fourth step 44, the sections Sᵢ, iε[1, N] are analyzed to determine those ones comprising a continuous fluid communication pathway from the first limit zone L₁ᵢ to the second limit zone L₂ᵢ. Those ones are renamed retained sections Rᵢ. The sub-set of parameters Mᵢ(r, z, θ) characterized the matter behind the casing for the section Sᵢ. In the embodiment here described, the measured parameter is the acoustic impedance and as already said above, the value of the impedance is translated in colors where intensity of the color is depended of the impedance and therefore informs on the probability of the material state: yellow for solid, blue for liquid and red for gas. The section Sᵢ can be delimited in zones where fluid flow can occur and/or exists and zones where fluid flow cannot occur and/or does not exist.

To determine zones where fluid flow can occur and/or exists each parameter Mᵢ(r, z, θ) may be interpreted separately or dependently of the neighborhood of said parameter Mᵢ(r, z, θ). The first solution is easier and corresponds to say if for a given parameter Mᵢ(r, z, θ) its value allows a fluid flow. Also when the parameter informs on the state of the matter, a fluid flow can occur when the state of the material is liquid or gas (color blue or red) and cannot occur when the state is solid (color yellow). The second solution is more complex and asks to analyze the neighborhood of Mᵢ(r, z, θ), to say if for a given parameter Mᵢ(r, z, θ) its value allows a fluid flow regarding the neighborhood of Mᵢ(r, z, θ). For example, when the fill material is cement and cement is partially debonded from the casing in a place, the acoustic impedance may be measured as impedance from gas for this place. The value of this impedance will be interpreted with the impedances in its neighborhood. And finally, this place will be interpreted as a zone where fluid flow cannot occur.

To determine if a continuous fluid communication pathway in section Sᵢ exists, it is verified that a continuous pathway exists from the first limit zone L₁ᵢ of section Sᵢ to the second limit zone L₂ᵢ for the same section Sᵢ through zones where fluid flow can occur. In another embodiment, a filter may be applied to the detected zones to only choose those ones, which are sufficiently important, in term of surface or volume. A threshold value may be given for a surface or a volume, and all detected zones above this threshold value will be effectively retained for the next step.

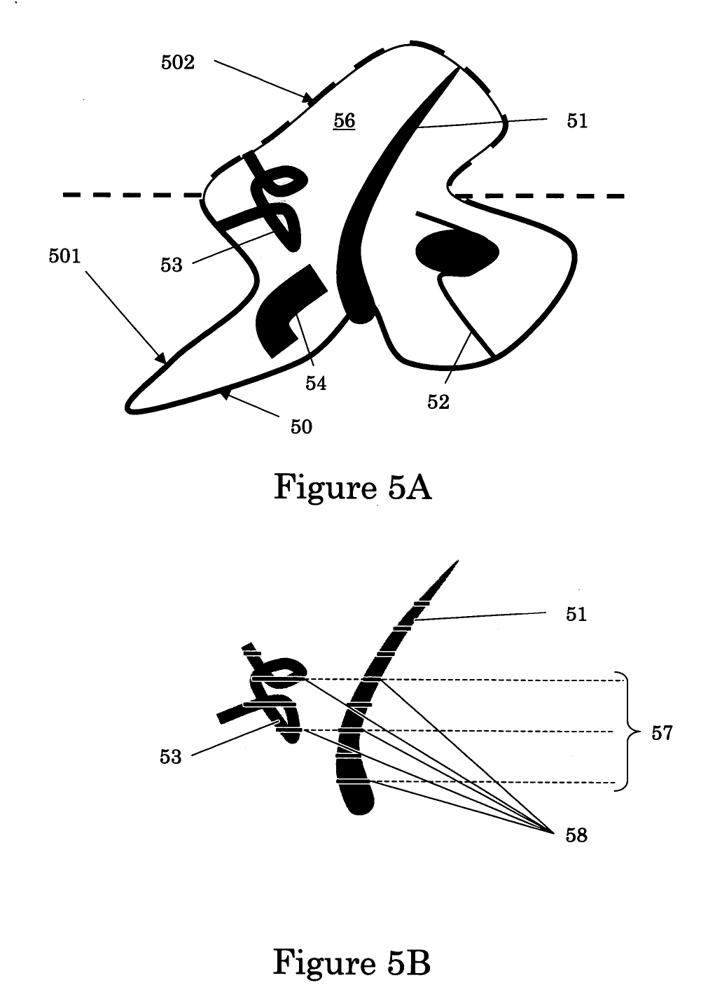

FIG. 5A is an example of determination of fluid communication pathway for a surface section (Sᵢ={M(z, θ), (z, θ)εEᵢ}, the radius is constant) of a sub-set of parameters Mᵢ(z, θ). The sub-set of parameters Mᵢ(z, θ) characterizing the matter behind the casing are translated in term of zones where fluid flow can occur (51, 52, 53 and 54) and zones where fluid flow cannot occur 56. The section Sᵢ is delimited by a frontier 50 and two limits are defined: a first limit zone 501 and a second limit zone 502. A continuous pathway exists from the first limit zone 501 to second limit zone 502 for the zones 51 and 53. Therefore, a continuous fluid communication pathway is possible in section Sᵢ and the section Sᵢ is renamed retained sections Rᵢ.

In a fifth step 45, for the retained sections Rᵢ, an area for a volume or a width for a surface versus depth of the continuous pathway is determined. When several distinct pathways are possible the area or width will be the sum of area or width of the distinct pathways. FIG. 5B is an example of determination of width of the fluid communication pathway for the two continuous pathways 51 and 53. The direction of depth is considered to be from up to down of the page. The width 58 of the continuous pathway is determined in the example for some depths 57. And finally, for retained section Rᵢ a function area sᵢ(z) is determined for (r, θ)εEᵢ representing for a given depth z the sum of the areas of the continuous pathways at this given depth z.

In a sixth step 46, a fluid communication index I(z) versus depth is extracted to characterize the material behind casing and its probability to possess hydraulic communication pathway. The fluid communication index I(z) is equal to zero for non-retained sections Sᵢ and is dependent of the function area Sᵢ(z) for the retained sections Rᵢ. Preferably, for the retained sections Rᵢ, the fluid communication index is equal to the function area sᵢ(z) normalized by the section area Rᵢ at depth z.

In a seventh step 47, the existence, the location and the intensity of a fluid communication pathway in the material behind casing wall is deduced. This method takes a great advantage from prior art, because with one curve representing the fluid communication index versus depth, we can ensure defects in the cement sheath and with which severity. The fluid communication index informs also on the possibility of repair, since a very small channel area could be difficult to perforate and squeeze.

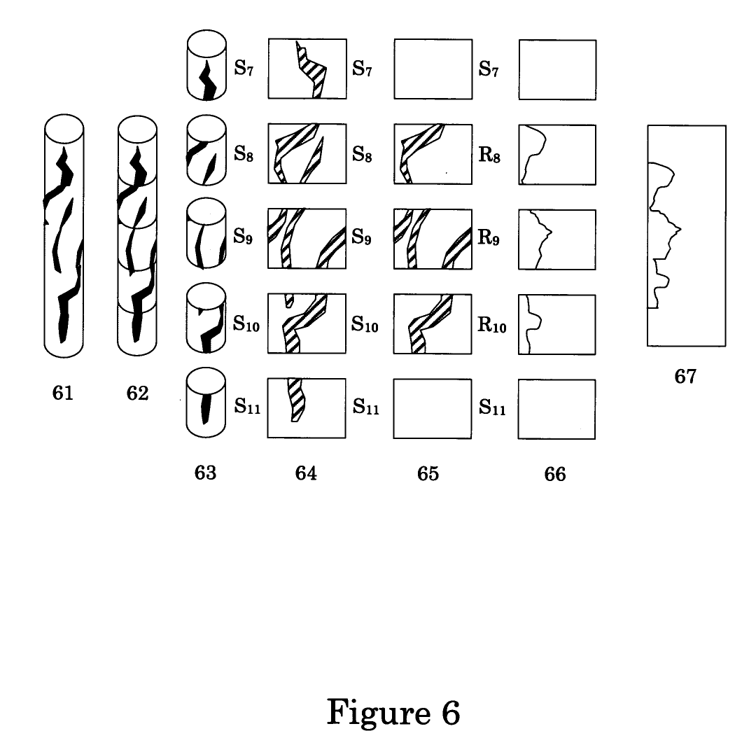

FIG. 6 is an example of application of the method according to the invention. A cylindrical map 61 informing on the characteristic of the matter behind the casing is plotted within a range of depths z and azimuthal angles θ (between 0 and 360 degrees). The cylindrical map is split regularly in cylindrical sections 62 and 63. The first limit zone for a section will be defined as the lower depth z and the second limit zone as the upper depth z. Each section has a constant level (for example 5 meters) and an azimuthal angle varying between 0 and 360 degrees. To analyze the data, the cylindrical sections are projected onto a plan map. For each section, from the measured characteristic of the matter behind the casing, section parts are delimited in zones where fluid flow can occur and/or exists (hachured zones) and zones where fluid flow cannot occur and/or does not exist 64. For each section it is determined if a continuous fluid communication pathway exists i.e., it is verified that a continuous pathway exists from the lower depth of section to the upper depth for the same section through zones where fluid flow can occur 65. This condition is ensured for sections S₈, S₉ and S₁₀; and they are renamed retained section R₈, R₉ and R₁₀. The width of the fluid communication pathway versus depth is determined and is plotted in a curve versus depth 66. The fluid communication index versus depth is finally extracted from said width versus depth 67.

### CROSS REFERENCE TO RELATED APPLICATIONS

This application claims priority to European patent application 04293063.6 filed Dec. 20, 2004.

1. A method for locating and measuring a fluid communication pathway in a material behind a casing wall, wherein said material is disposed in an annulus between said casing and a geological formation, said method using a logging tool positionable inside the casing and said method comprising: detecting a set of parameters of the material behind the casing at different positions with said logging tool, evaluating location of fluid communication pathway from said set of parameters and said positions, and measuring size of said fluid communication pathway from said set of parameters.

2. The method of claim 1, further comprising guiding and rotating the logging tool inside the casing in order to evaluate the description of the material behind the casing within a range of radius, depths and azimuthal angles.

3. The method of claim 1, comprising the step of:
(i) measuring a set of parameters M of the material behind the casing within a range E of radius, depths and azimuthal angles (41);
(ii) defining sections Sᵢ comprising a sub-set of parameters Mᵢ wherein said sub-set of parameters Mᵢ is taken in said set of parameter M for a given range Eᵢ of radius, depths and azimuthal angles included in said range E of radius, depths and azimuthal angles (42);
(iii) defining for each section Sᵢ a first limit zone L₁ᵢ and a second limit zone L₂ᵢ in frontier of the range Eᵢ (43);
(iv) determining among said sections Sᵢ the ones that comprise a continuous fluid communication pathway from said first limit zone L₁ᵢ to said second limit zone L₂ᵢ, said sections Sᵢ being renamed in retained sections Rᵢ (44);
(v) determining from said continuous fluid communication pathway an area sᵢ of pathway versus depth for each of said retained sections Rᵢ (45);
(vi) extracting a fluid communication index versus depth for the material behind the casing (46), wherein said fluid communication index versus depth:
a. depends of sᵢ for retained sections Rᵢ and,
b. is equal to zero for non retained sections Sᵢ;
(vii) deducing from said fluid communication index the existence and location of fluid communication pathway in said material behind said casing wall (47).

4. The method of claim 3, wherein sections Sᵢ are surfaces and step (v) is replaced by determining from said continuous fluid communication pathway a width sᵢ of pathway versus depth for each of said retained sections Rᵢ.

5. The method according to claim 1, wherein the set of parameters of the material behind the casing is any taken in the list of: density of the material, acoustic impedance of the material, state of the material, shear wave velocity or compressional wave velocity of the material.

6. The method of claim 3, wherein the range E is defined by a minimum radius and a maximum radius; a minimum depth and a maximum depth; and an angle varying between zero and three hundred sixty degrees.

7. The method of claim 6, wherein the sections Sᵢ are cylindrical sections with a range Eᵢ defined by a minimum radius and a maximum radius; a minimum depth and a maximum depth; and an angle varying between zero and three hundred sixty degrees.

8. The method according to claim 3, wherein the range E is defined by a minimum depth and a maximum depth; and an angle varying between zero and three hundred sixty degrees.

9. The method of claim 8, wherein the sections Sᵢ are cylindrical sections with a range Eᵢ defined by a minimum depth and a maximum depth; and an angle varying between zero and three hundred sixty degrees.

10. The method of claim 7, wherein for each section Sᵢ, the first limit zone L₁ᵢ is the frontier defined at lower depth of said section Sᵢ and the second limit zone L₂ᵢ is the frontier defined at upper depth of said section Sᵢ.

11. The method according to claim 3, wherein said fluid communication index versus depth is a linear dependency of sᵢ for retained sections Rᵢ.

12. The method according to claim 3, wherein the continuous fluid communication pathway is determined by the step of:
a. defining from the sub-set of parameters Mᵢ, zones where a fluid can exist;
b. determining if a continuous pathway is possible through said zones.

13. The method of claim 12, further comprising the step of applying a filter to said zones where a fluid can exist to retain only preferential zones above a predefined threshold value of surface or volume.

14. The method according to claim 1, wherein the material is cement.

15. The method according to claim 3, wherein the set of parameters of the material behind the casing is any taken in the list of: density of the material, acoustic impedance of the material, state of the material, shear wave velocity or compressional wave velocity of the material.

16. The method of claim 15, wherein the range E is defined by a minimum radius and a maximum radius; a minimum depth and a maximum depth; and an angle varying between zero and three hundred sixty degrees.

17. The method of claim 15, wherein the range E is defined by a minimum depth and a maximum depth; and an angle varying between zero and three hundred sixty degrees.

18. The method of claim 15, wherein said fluid communication index versus depth is a linear dependency of sᵢ for retained sections Rᵢ.

19. The method according to claim 15, wherein the continuous fluid communication pathway is determined by the step of:
c. defining from the sub-set of parameters Mᵢ, zones where a fluid can exist;
d. determining if a continuous pathway is possible through said zones.

20. The method according to claim 15, wherein the material is cement.
